(19) United States
(12) Patent Application Publication
(10) Pub. No.: US 2015/0190882 A1
(43) Pub. Date: Jul. 9, 2015

(54) ASSEMBLY FOR PROCESSING WORK PIECES WITH A LASER BEAM

(71) Applicant: ROFIN-LASAG AG, THUN (CH)

(72) Inventors: CHRISTOPH RUETTIMANN, THUN (CH); ULRICH DUERR, ALLMENDINGEN (CH); RICHARD BARTLOME, PRANGINS (CH)

(21) Appl. No.: 14/616,906

(22) Filed: Feb. 9, 2015

Related U.S. Application Data
(63) Continuation of application No. PCT/EP2013/066723, filed on Aug. 9, 2013.

(30) Foreign Application Priority Data
Aug. 9, 2012 (EP) 12179826.8

(51) Int. Cl. B23K 26/00; H01S 3/102; H01S 3/067; H01S 3/00; B23K 26/06; B23K 26/03

(52) U.S. Cl. CPC B23K 26/0009; B23K 26/0643; B23K 26/032; B23K 26/063; H01S 3/067; H01S 3/0064; H01S 3/1024

(57) ABSTRACT

An assembly for processing a work piece using a laser beam, in particular for processing a highly reflective work piece, includes a fiber laser as a laser beam source for producing a pulsed primary laser beam having a bandwidth that is less than 1 nm.

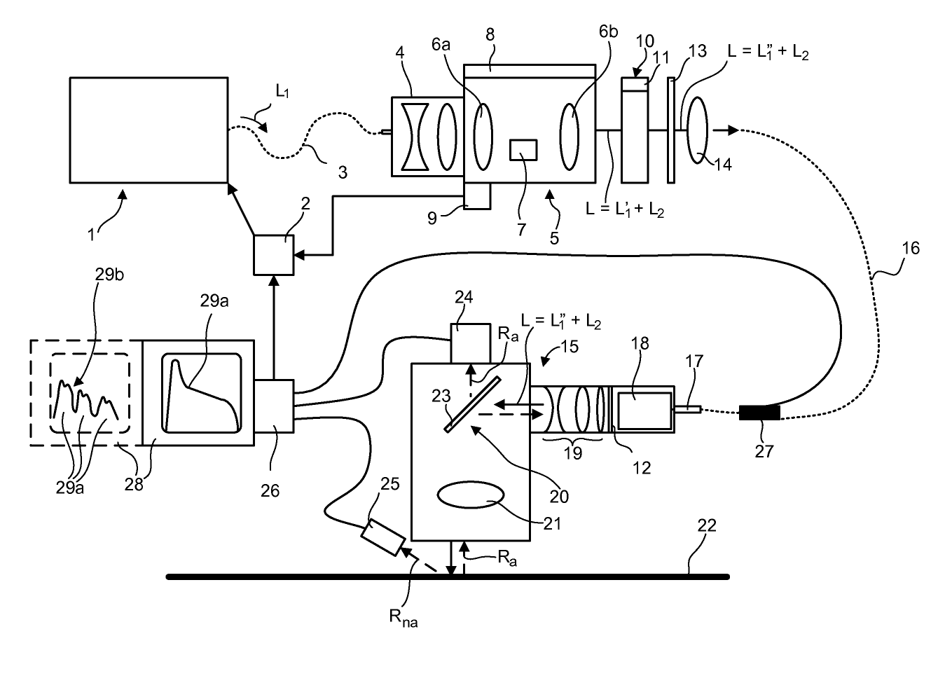

### CROSS-REFERENCE TO RELATED APPLICATION

This is a continuation, under 35 U.S.C. §120, of copending International Application No. PCT/EP2013/066723, filed Aug. 9, 2013, which designated the United States; this application also claims the priority, under 35 U.S.C. §119, of European Patent Application EP 12 179 826.8, filed Aug. 9, 2012; the prior applications are herewith incorporated by reference in their entirety.

### BACKGROUND OF THE INVENTION

### Field of the Invention

The invention relates to an assembly for processing, in particular for welding, a work piece using a laser beam.

Processing by drilling, separating or welding of work pieces by using a laser beam is associated with a multiplicity of technical advantages including, inter alia, a reduced heat input compared with other processing methods and also the possibility of being able to carry out processing on locations that are difficult to access, and in particular to produce weld seams having complex seam contours. Difficulties are posed, however, by the processing of highly reflective work pieces such as, for example, copper or aluminum, and of other highly reflective materials in the electronics, medical or jewelry industry.

### SUMMARY OF THE INVENTION

It is accordingly an object of the invention to provide an assembly for processing a work piece with a laser beam, which overcomes the hereinafore-mentioned disadvantages of the heretofore-known assemblies of this general type and which is suitable, in particular, for processing highly reflective work pieces, especially highly reflective metallic work pieces.

With the foregoing and other objects in view there is provided, in accordance with the invention, an assembly for processing a work piece by using a laser beam, in particular for processing a highly reflective work piece, which comprises a fiber laser as a laser beam source for generating a pulsed primary laser beam having a bandwidth that is less than 1 nm.

In accordance with another feature of the invention, the fiber laser preferably generates a linearly polarized primary laser beam.

In accordance with a further feature of the invention, the fiber laser is a single-mode or low-mode fiber laser.

In accordance with an added feature of the invention, the fiber laser is a qcw fiber laser.

In accordance with an additional feature of the invention, a frequency multiplier module for generating at least one frequency-multiplied secondary laser beam is disposed in the beam path of the primary laser beam. The absorption is improved and the processing quality and reproducibility in the case of highly reflective work pieces are significantly improved.

In accordance with yet another feature of the invention, an optical adjustment module is disposed in the beam path of the laser beams emerging from the frequency multiplier module, through the use of which optical adjustment module the intensity of the remaining primary laser beam, i.e. the primary laser beam not converted into a laser beam having a multiplied frequency in the frequency multiplier module, is settable relative to the intensity of the secondary laser beam or beams, in order to be able to adapt the total radiation energy to the processing geometry (e.g. welding depth), and in particular to suppress the formation of sputter during welding.

In accordance with yet a further advantageous feature of the invention, a circular polarizer is disposed downstream of the frequency multiplier module. In this way, it is possible to avoid effects that can arise as a result of a dependence of the absorption properties of the work piece on the direction of polarization of a linearly polarized laser beam.

In a further preferred embodiment, one or a plurality of transport fibers are provided for guiding the laser beams, wherein all of the transport fibers have a core diameter that is greater than 15 μm. The coupling-in of the laser beams is facilitated by using such a transport fiber. Moreover, the beam quality is maintained and nonlinear effects are suppressed.

In accordance with yet an added feature of the invention, the assembly includes a processing head, which includes a collimator device, a deflection optical unit and a focusing optical unit for focusing the laser beam or beams onto the work piece.

In accordance with yet an additional preferable feature of the invention, the optical components situated in the beam path of the laser beams are formed of quartz glass.

In accordance with again another preferred feature of the invention, provision is made for a device for coupling out and detecting radiation emerging axially from the work piece.

In accordance with again a further feature of the invention, for this purpose, in a first embodiment, the fixed or moveable deflection optical unit includes a deflecting mirror, which is highly reflective in a narrowband fashion for the primary laser beam and the secondary laser beam or the secondary laser beams and which is transmissive for plasma radiation and thermal radiation emerging from the work piece.

In accordance with again an added feature of the invention, as an alternative thereto, in a second preferred embodiment, the radiation emerging axially from the work piece can be coupled out from a transport fiber through a fiber-optic beam splitter.

In accordance with a concomitant feature of the invention, if the radiation emerging from the work piece is analyzed in a signal processing unit and control signals for controlling the processing process are generated on the basis of this analysis, the processing quality can be controlled and significantly improved by adaptation of the laser beams used for the processing. The radiation emerging from the work piece can be reflected laser radiation, thermal radiation emerging from the processing zone or plasma radiation emerging from a plasma formed in the processing zone, wherein in particular the shape of an individual pulse and also the shape of a pulse train of the radiation emerging from the work piece are used for the analysis.

Other features which are considered as characteristic for the invention are set forth in the appended claims.

Although the invention is illustrated and described herein as embodied in an assembly for processing work pieces by using a laser beam, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The FIGURE of the drawing is a schematic and block diagram of an exemplary embodiment of an assembly according to the invention, which is used to explain the invention in greater detail.

### DETAILED DESCRIPTION OF THE INVENTION

Referring now in detail to the single FIGURE of the drawing, there is seen an assembly which includes a fiber laser 1, preferably a qcw or modulated cw fiber laser having radiation in the near infrared (1-2 μm), which is constructed to generate a quasi-continuous, preferably linearly polarized, primary laser beam L₁ that is present in a single mode or a multimode with a low number of modes and which has a bandwidth that is less than 1 nm, and the pulse duration of which is between 10 μs and 50 ms. The fiber laser 1 can be operated both in single-pulse operation and with a pulse frequency of up to 100 kHz. In one advantageous development, moreover, the pulses or pulse trains generated by the fiber laser 1 can be shaped by corresponding driving of pump diodes used for optical pumping. The fiber laser 1 is controlled by a control unit 2.

The primary laser beam L₁ present with a Gaussian cross-sectional profile is coupled into a frequency multiplier module 5 through a preferably polarization-maintaining first transport fiber 3 and a first collimating optical unit 4. The frequency multiplier module 5 includes a nonlinear crystal 7, for example KTP or LBO, which is disposed between a focusing optical unit 6a and a second collimating optical unit 6b. The transport fiber 3 is short enough to largely avoid an increase in bandwidth caused by nonlinear optical effects in the fiber, and to limit the bandwidth to values of less than 1 nm. The first transport fiber 3 is preferably a large-core single-mode or low-mode fiber, the core diameter of which is greater than 15 μm.

A thermostat device 8 is used for stabilizing the temperature of the nonlinear crystal 7. In addition, by using a sensor device 9, a measurement value corresponding to the intensity of the primary laser beam L1 coupled into the frequency multiplier module 5 is measured and fed to the control unit 2 for monitoring and control of the fiber laser 1.

In an alternative embodiment, the frequency multiplier module 5 is mounted directly downstream of the output of the fiber laser 1 without the interposition of a first transport fiber 3.

The laser beam L emerging from the frequency multiplier module 5 is composed of a remaining (frequency multiplication efficiency typically <50%) primary laser beam L₁′ having the frequency ω, and a frequency-multiplied secondary laser beam L₂ having the frequencies 2 ω or 3 ω. The primary laser beam L₁′ and the secondary laser beam L₂ are guided through an optical adjustment module 10, with which the intensity ratio between the remaining primary laser beam L₁′ and the secondary laser beam L₂ can be set. The optical adjustment module 10 used for this purpose is, for example, a graduated filter which serves as a cut-off filter for the remaining primary laser beam L₁′ and the transmissivity of which for the primary laser beam L₁′ can be set automatically between typically 10-100%. The cut-off filter simultaneously transmits the secondary laser beam L₂. The primary laser beam which is not transmitted, i.e. reflected, by the optical adjustment module 10 is guided into an absorber 11.

In an alternative embodiment, the optical adjustment module 10 includes a wavelength-selective electro-optical or acousto-optical element which guides part of the remaining primary laser beam L₁′ into the absorber 11 in a settable manner.

The laser beam L which emerges from the optical adjustment module 10 and is composed of a residual primary laser beam L₁″ and the secondary laser beam L₂ is coupled through an optical polarization-independent isolator 13 and a focusing optical unit 14 into a second transport fiber 16, which leads to a processing head 15, and is coupled out from the second transport fiber into a collimator device 17 disposed in or on the processing head 15, a first beam shaping device 18 and a circular polarizer (λ/4 plate) 12.

The optical isolator 13 serves to reduce laser radiation reflected from the work piece, with the laser radiation principally being a reflected primary laser beam, to such an extent that it does not adversely affect the operation of the fiber laser 1.

The second transport fiber 16 is a large-core single-mode fiber or a low-mode fiber having a core diameter that is typically greater than 15 μm. The properties of the transport fiber 16 are preferably chosen in such a way that from the original Gaussian profile a different beam profile, e.g. a top hat profile or a doughnut profile, arises at the output of the transport fiber particularly in the case of a residual primary laser beam L₀″.

In an alternative embodiment, the original beam profile is maintained in the transport fiber 16 and at the output of the second transport fiber 16, with the aid of the first beam shaping device 18, the shape of the intensity profile, for example a doughnut profile, a top hat profile or some other Gaussian profile, is set in order to ensure that the processing zone is heated as homogeneously as possible.

The diameter of the residual primary laser beam L₁″ and of the secondary laser beam L₂ can be varied by using a second beam shaping device 19 disposed in the processing head 15. The two beam shaping devices 18 and 19 can also form one unit.

The laser beam L (L₁″ and L₂) which is shaped in this way passes through a deflection optical unit 20 to a focusing optical unit 21, which focuses the laser beam L on a work piece 22. The deflection optical unit 20 includes either a mirror configuration for lateral beam deflection (parallel to the work piece surface), for example a 2D scanner or a 3D scanner, or in an alternative embodiment, illustrated in the figure, a wavelength-selective and spatially selective, fixedly installed deflecting mirror 23, which on one hand guides the laser beam L onto the work piece 22 and on the other hand transmits axial radiation Rₐ occurring during the laser processing of the work piece 22, i.e. radiation emerging from a welding location counter to the direction of the laser beam L impinging on the work piece 22. After passing through the wavelength-selective and spatially selective deflection mirror 23, the intensity of the radiation is detected by using a sensor 24. The spatially selective property of the deflecting mirror 23 resides in the fact that the mirror is reflective for the wavelengths of the laser beam L only in a limited region, or else the mirror is transmissive outside this region. This makes use of the fact that the aperture of the radiation Rₐ emerging from the work piece 22 is greater than the aperture of the laser beam L on the deflecting mirror 23, and so the latter need only be reflective in this region. In this way, the deflecting mirror 23 and the sensor 24 form a device for coupling out and detecting the radiation emerging axially from the work piece 22.

A non-axial optical radiation Rₙₐ emerging from the processing location is additionally detected directly in a further sensor 25. The measurement signals detected by the sensors 24, 25 are forwarded to a signal processing unit 26. Control signals for the control unit 2 controlling the fiber laser 1 are generated in the signal processing unit 26 from the measurement signals.

As an alternative to the embodiment shown, the optical signals R_{a,na} can also first be coupled into optical fibers and transported to the signal processing unit 26, in which the sensors 24, 25 are then integrated.

With the aid of the measurement signals generated by the sensors 24, 25, it is possible to monitor the processing operation and to control the processing process by using the signal processing unit 26.

In one particular advantageous variant, the fixed or moveable deflection optical unit 20 does not include a wavelength-selective and spatially selective deflecting mirror 23, so that the radiation emerging from the processing location in an axial direction, such as e.g. the reflected beams, the plasma radiation or the thermal radiation, is coupled again into the core and cladding of the transport fiber 15. In this embodiment, the radiation returning from the work piece 22 is coupled out by using a fiber-optic beam splitter 27 in the transport fiber 15 and is analyzed further in the signal processing unit 26.

The figure additionally illustrates a monitor 28, on which a pulse 29a of the radiation emerging from the processing location is presented. By way of example, information about the dynamic absorption behavior of the processing location during the pulse duration can be derived from the shape of such a pulse 29a, since absorption is temperature-dependent in the case of metals. This information can then be used for controlling the processing process.

The figure additionally illustrates a pulse train 29b, which can likewise be represented on the monitor 28. It is possible to detect local variations on the work piece 22 from the relative behavior of the pulses 29a of such a pulse train 29b, whether the variations are a variation of the surface or a geometrical variation during the processing on the work piece. This may be, during welding, for example, welding defects such as sputter on the welding location or else undesired holes. This possibility of analysis conversely also provides assistance in identifying successful laser beam drilling and cutting.

In a different embodiment with the optical isolator 13 removed, the radiation fed back into the second transport fiber 16 can also be tapped off at the laser-side transport fiber 3 or in the fiber laser 1 itself through fiber-optic beam splitters and can be fed for the analysis and process control.

The assembly according to the invention is particularly suitable for the laser processing of copper, aluminum or other highly reflective materials in the electronics, medical or jewelry industry.

Although the invention has been more specifically illustrated and described in detail by using the preferred exemplary embodiment, the invention is not restricted by the examples disclosed and other variations can be derived therefrom by the person skilled in the art, without departing from the scope of protection of the invention.

1. An assembly for processing a work piece, including a highly reflective work piece, with a laser beam, the assembly comprising:
a fiber laser provided as a laser beam source configured to generate a pulsed primary laser beam having a bandwidth being less than 1 nm.

2. The assembly according to claim 1, wherein the primary laser beam is linearly polarized.

3. The assembly according to claim 1, wherein said fiber laser is a single-mode or low-mode fiber laser.

4. The assembly according to claim 1, wherein said fiber laser is a qcw fiber laser.

5. The assembly according to claim 1, which further comprises a frequency multiplier module disposed in a beam path of the primary laser beam for generating a frequency-multiplied secondary laser beam.

6. The assembly according to claim 5, which further comprises an optical adjustment module disposed in a beam path of laser beams emerging from said frequency multiplier module, said optical adjustment module being configured to set an intensity of the primary laser beam relative to an intensity of the secondary laser beam.

7. The assembly according to claim 3, which further comprises at least one transport fiber configured to guide the laser beam, said at least one transport fiber having a core diameter greater than 15 μm.

8. The assembly according to claim 5, which further comprises at least one transport fiber configured to guide the laser beams, said at least one transport fiber having a core diameter greater than 15 μm.

9. The assembly according to claim 5, which further comprises a circular polarizer disposed downstream of said frequency multiplier module.

10. The assembly according to claim 5, which further comprises a processing head including a collimator device, a deflection optical unit and a focusing optical unit configured to focus the laser beams onto the work piece.

11. The assembly according to claim 5, which further comprises optical components formed of quartz glass being situated in the beam path of the laser beams.

12. The assembly according to claim 10, which further comprises a device for coupling out and detecting radiation emerging axially from the work piece.

13. The assembly according to claim 12, wherein said deflection optical unit includes a deflecting mirror being highly reflective in a narrowband fashion for the primary laser beam and the secondary laser beam or secondary laser beams and being transmissive for a plasma radiation and thermal radiation emerging from the work piece.

14. The assembly according to claim 12, which further comprises a transport fiber configured to guide the laser beam, and a fiber-optic beam splitter configured to couple radiation emerging axially from the work piece out from said transport fiber.

15. The assembly according to claim 12, which further comprises a signal processing unit configured to analyze a variation of at least one of pulse shape or pulse trains and a temporal profile of radiation emerging from the work piece during processing and to generate control signals for controlling a processing process based on the analysis.
